(19) United States
(12) Patent Application Publication
(10) Pub. No.: US 2002/0033039 A1
(43) Pub. Date: Mar. 21, 2002

(54) Hand tool for crimping ferrules comprising a removable ferrule loader, associated ferrule loader, and hand tool for crimping strings of ferrules comprising improved string-cutting means

(76) Inventors: Robert Gautheret, Besancon (FR); Laurent Rouiller, Fraisans (FR)

Correspondence Address: WENDEROTH, LIND & PONACK, L.L.P., 2033 K STREET N. W., SUITE 800, WASHINGTON, DC, 20006-1021, US

(21) Appl. No.: 09/994,759

(22) Filed: Nov. 28, 2001

(30) Foreign Application Priority Data
Jan. 12, 2000 (FR) 00 15612
Jan. 12, 2000 (FR) 00 15617

(51) Int. Cl. B25C 5/00

(52) U.S. Cl. 72/409.04

(57) ABSTRACT

This hand tool for crimping ferrules, comprises a body (12) extended by a first branch (15) forming a hand grip, and a second branch (18) forming a hand grip, articulated to the body (12), a crimping chamber (27) being formed in the said body (12) and opening to the outside of the body (12) via a passage (25) for the introduction of one end of an electric conductor into the said crimping chamber (27), a channel (38) being formed in the said body (12) and/or the said first branch (14), a ferrule loader (33) arranged at least partially and removably in the said channel (38) so as to open into the crimping chamber (27).

The loader (33) comprises at least two magazines (42, 43) designed each to receive a number of ferrules.

A first aspect of the invention relates to a hand tool for crimping ferrules, particularly of the pliers type, comprising a body extended by a first branch forming, in particular, a hand grip, and a second branch forming, in particular, a hand grip, articulated to the body, a crimping chamber being formed in the said body and opening to the outside of the body via a passage for the introduction of one end of an electric conductor into the said crimping chamber, a channel being formed in the said body and/or the said first branch, a ferrule loader arranged at least partially and removably in the said channel so as to open into the crimping chamber, the loader comprising at least two magazines designed each to receive a number of ferrules.

The term “ferrule” is naturally here to be understood as meaning a crimp-on wiring accessory, in the broadest sense, which may, for example, denote a terminal.

However, the invention is particularly applicable to ferrules with insulated flange intended for connecting a flexible conductor provided with an insulated sheath, which are generally used in low-voltage industrial electrical apparatuses. Such ferrules are very widely used and are defined, for example, in standardization documents (French standard NF C 63-023).

The standards which define this type of ferrule with insulated flange set out standard dimensions covering all common industrial requirements.

Numerous pairs of crimping pliers of the aforementioned type, designed to perform crimping operations with ferrules of different sizes are already known from the state of the art. In general, the known ferrule loaders contain a great many ferrules of the same size, with the operator having to change the loader each time he wishes to work with ferrules of different types.

Commonly, a terminal block of industrial type may have at least six types of connection depending on the nominal cross section of the conductor used, and therefore six types of ferrule, which means that that the operator, during the crimping operation, has either to use several pairs of crimping pliers or to change frequently between ferrule loaders, and therefore perform repeated operations of setting the loader to the pliers and removing it.

In the first instance, the amount of hardware used is a source of confusion and error in crimping operations and represents a prohibitive cost.

In the second instance, the repeated operations of fitting and removing the loader lead to a significant loss of time.

A main objective of the invention is to overcome these drawbacks by simplifying the task of the operator when he has to switch from one type of ferrule to another, and by reducing the number of operations needed for this switchover.

To this end, according to the invention, the loader is mounted so that it can be moved in the channel between at least two positions in which just one of the magazines opens opposite the passage, and the said tool comprises locking and selecting means designed to hold the loader in the channel in one of the said positions selectively.

By virtue of this provision, the mechanical means used which allow the switch from one type of ferrule to another are robust and of simple design.

The invention is also aimed at a ferrule loader for a crimping hand tool of the type described hereinabove, the said loader being in the form of a strip which is elongate in a main direction, in which a series of ferrules of the same size, connected together, is held between a pair of roughly parallel walls forming a magazine, the said series of ferrules being able to slide as a unit in the main direction between the said walls, the loader being characterized in that it has at least two such magazines running parallel to one another and designed each to accommodate a number of different ferrules.

A second aspect of the invention relates to a tool for crimping strings of ferrules, the said string being intended to travel in its longitudinal direction, the said tool comprising a body in which there is formed a crimping chamber opening to the outside of the body via a passage for the introduction of one end of a wire-like element into the said chamber, a crimping mechanism arranged in the said crimping chamber, the said mechanism comprising an anvil designed to accommodate part of a ferrule that is to be crimped, a moving punch intended to deform the said part by pressing it against the said anvil, and a moving member for cutting the string.

When they are in a string, the ferrules are connected by a plastic film moulded with the insulated collar.

In known devices, the cutting member is adjusted, generally by hand, so that it describes a very precise fixed angle with respect to the travel of the punch, so that the plastic film is cut between two consecutive ferrules, while the conducting sleeve of the ferrule that is to be crimped is deformed by the punch. Switching between ferrules entails changing the adjustment of the cutting member.

A main objective of the invention is to overcome this drawback by simplifying the task that the operator must perform when he wishes to switch from one type of ferrule to another, as mentioned previously.

To this end, according to the invention, the cutting member is capable of excursion with respect to the direction of action of the punch.

The invention finds a particularly beneficial application in crimping pliers of the type comprising a body extended by a first branch forming a hand grip and by a second branch forming a hand grip, articulated to the body, a channel being formed in the said first branch, the said channel removably accommodating a ferrule loader and opening into the crimping chamber.

In this embodiment of the invention, the loader comprises at least two magazines respectively corresponding to ferrules of different sizes, and the pliers comprise locking and selecting means designed to hold the loader in the channel in, selectively, one of the positions in which one of the magazines opens opposite the passage.

The invention will be better understood from reading the description which will follow which is given merely by way of example and made with reference to the appended drawings in which:

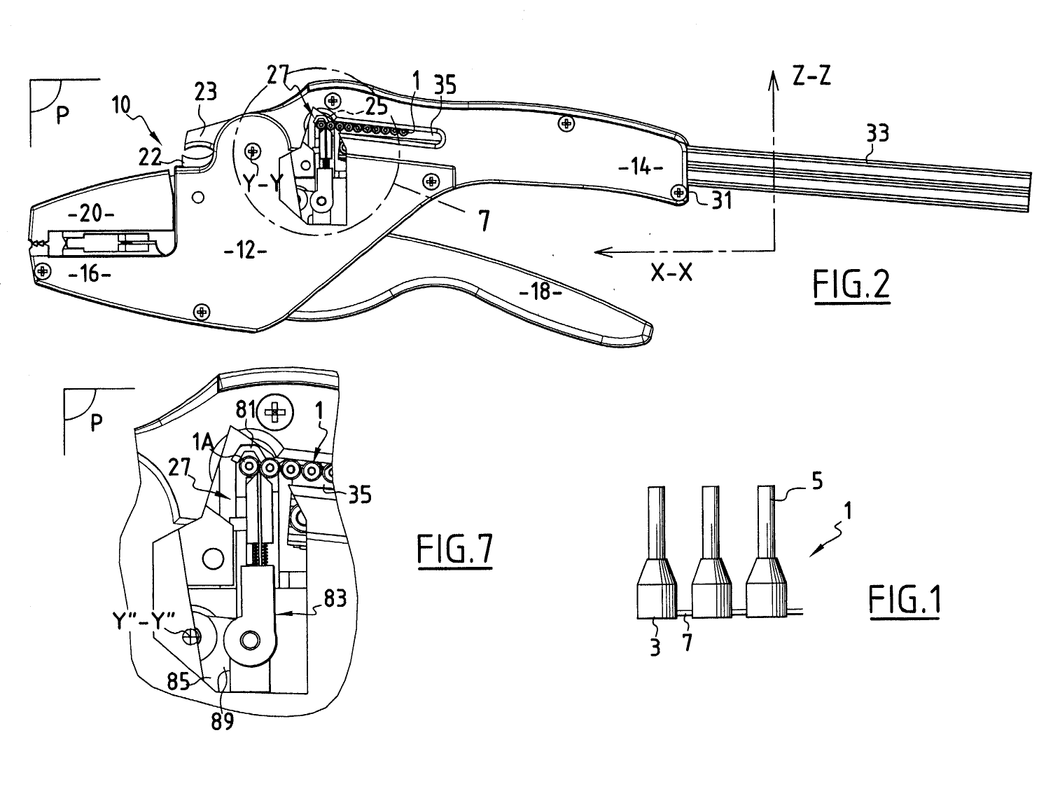

FIG. 1 is a view in elevation of ferrules with insulated collar in string form, as used in crimping pliers according to the invention;

FIG. 2 is a view in elevation of crimping pliers equipped with a ferrule loader according to the invention;

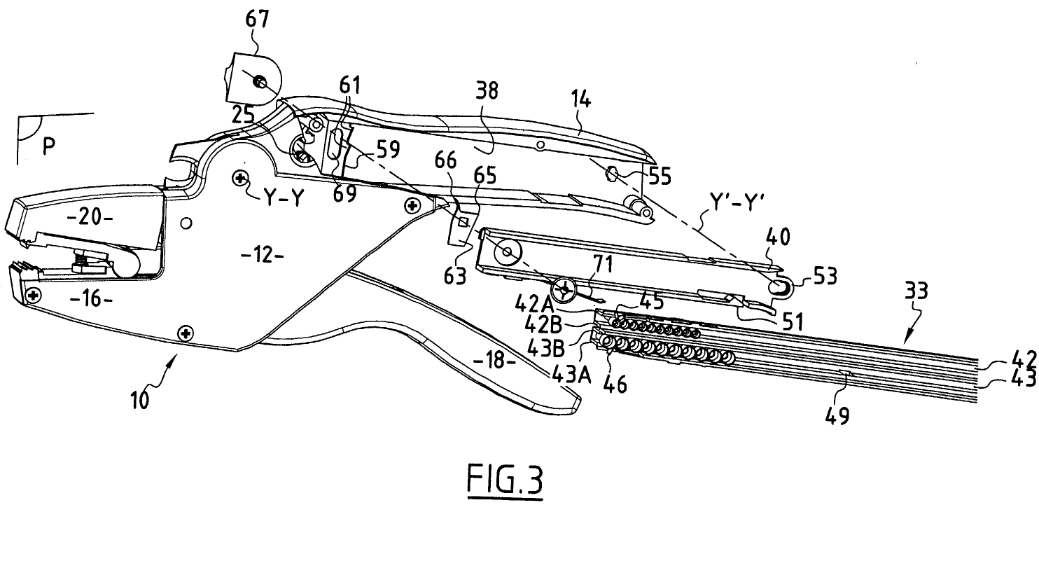

FIG. 3 is an exploded view of the pliers and of the ferrule loader which are depicted in FIG. 2, according to a first embodiment of the invention;

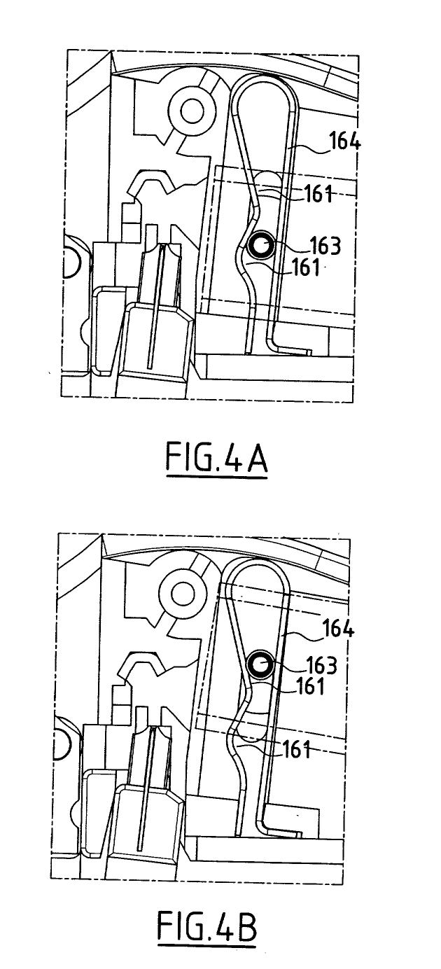

FIGS. 4A and 4B are detail views showing the means of immobilizing the loader, according to a second embodiment of the invention in, respectively, a first position and a second position;

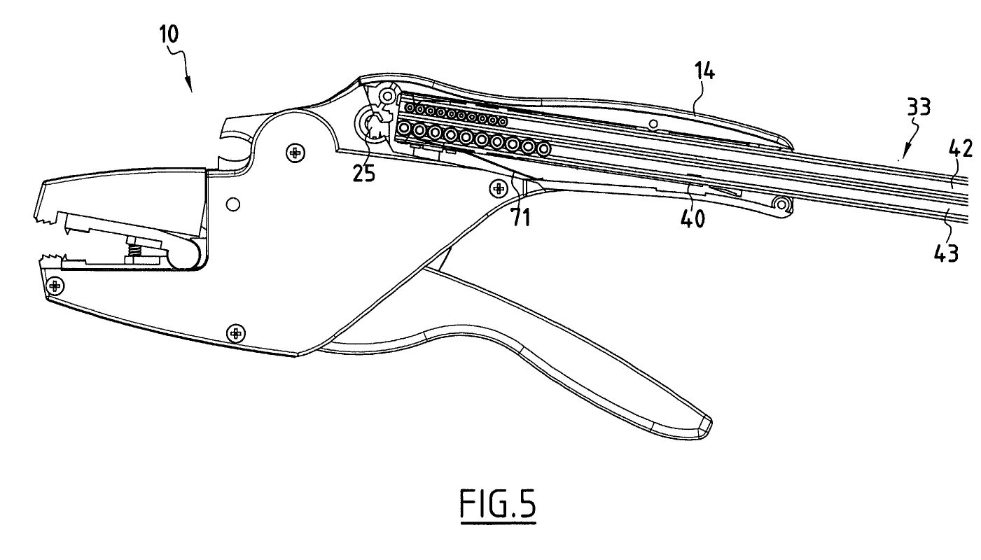

FIG. 5 is a view similar to FIG. 2, corresponding to either one of the two embodiments, with one wall of the hand grip accommodating the ferrule loader partially cut away, the loader being in a first position;

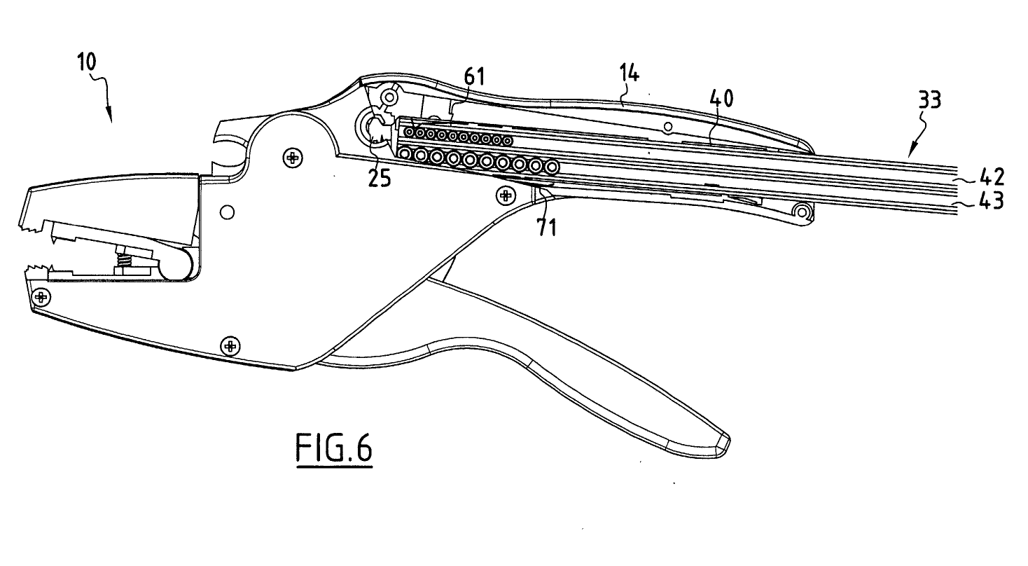

FIG. 6 is a view similar to FIG. 5, the ferrule loader being in a second position;

FIG. 7 is a detail view of FIG. 2, which depicts the crimping chamber and the crimping tool;

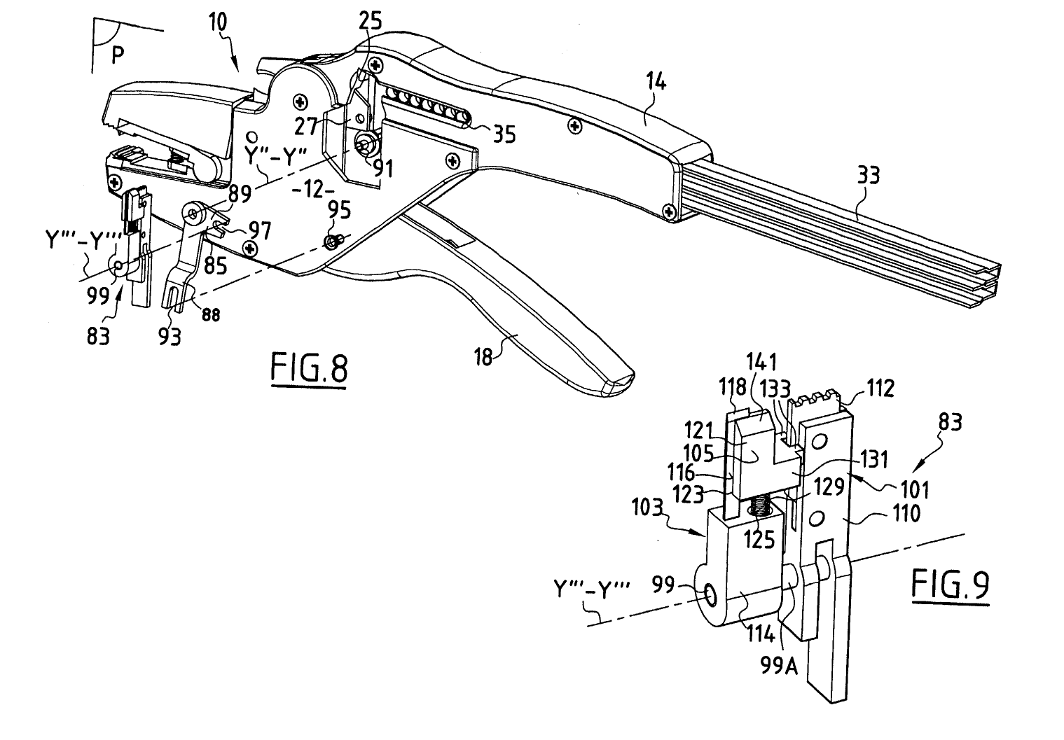

FIG. 8 is a partially exploded perspective view of the pliers depicted in FIGS. 2 to 7, more specifically showing the crimping tool and a member for driving the said tool;

FIG. 9 is a partial perspective view of the crimping tool alone, which view depicts the punch, the centring member and the cutting member; and

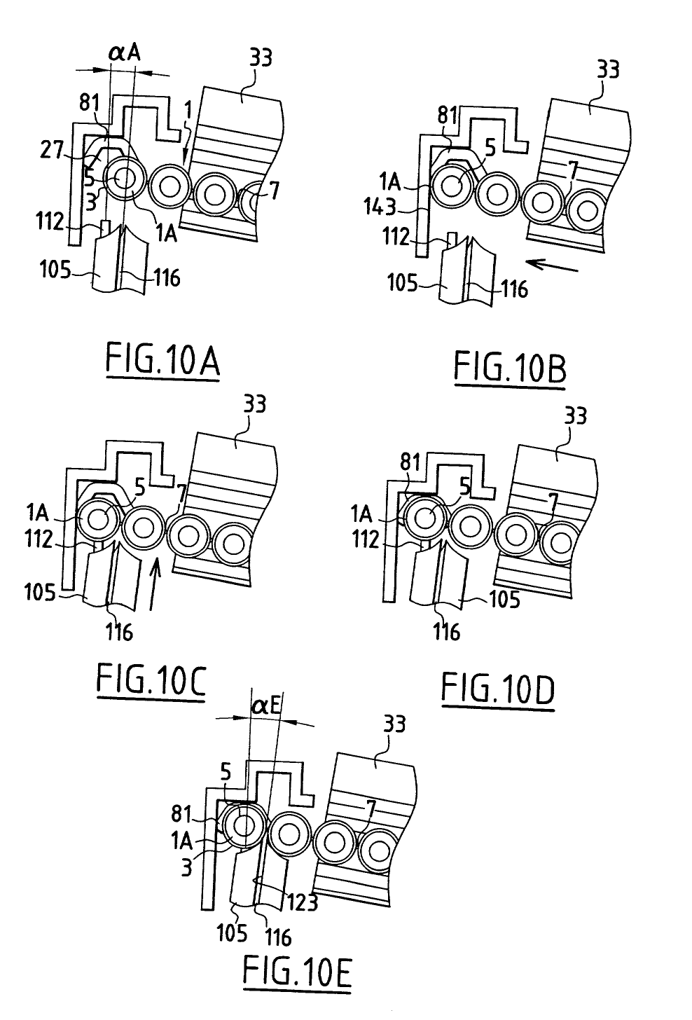

FIGS. 10A to 10E are schematic views in elevation of the crimping tool and of a series of ferrules to be crimped, in successive phases of the crimping operation.

FIG. 1 depicts a series of ferrules in a string, of the type commonly used in the applications mentioned in the preamble of this application. A ferrule 1 essentially comprises an insulated cylindrical sleeve 3 secured to a coaxial conducting cylindrical sleeve 5, of smaller diameter. The insulated sleeve 3 is intended to accommodate the insulated sheath of an electric conductor, while the conducting sleeve 5 is intended to accommodate the conducting core and to be deformed onto it during the crimping operation.

The ferrules 1, as they are generally used in crimping pliers, are in the form of elongate strings in which the ferrules 1 are arranged parallel to one another, oriented in the same way, the axis of the ferrules being orthogonal to the longitudinal direction of the string.

Two consecutive ferrules 1 are connected by a plastic film 7, for example moulded with the insulated sleeves 3, the plastic film 7 joining two consecutive insulated sleeves 3 together near their free end, in the part of minimum distance between the two cylinders.

It will be appreciated that the plastic film 7 runs in the longitudinal direction of the string and that this film 7 is intended to be cut through during the operation of crimping a ferrule 1 onto an electric conductor, so as to detach this ferrule 1 from the string.

FIG. 1 depicts just three ferrules, but the strings of ferrules as used commonly contain a great many of these. It goes without saying that, since the plastic film 7 is relatively flexible, the string can be laid out flat, as depicted, in a spiral, in a winding path or in any other form suited to the various types of loader used.

FIG. 2 depicts crimping pliers 10 according to the invention, designed for ferrules 1 of different sizes and of the overall form depicted in FIG. 1.

For the convenience of the description, the pliers will be orientated along the horizontal axis X-X and vertical axis Z-Z as depicted in FIG. 2 so as to define, throughout what follows, the terms “top”, “0bottom”, “lower”, “upper”, “front”, “rear”, etc.

The pliers 10 depicted are of the multipurpose type because they can be used to perform several types of operation, namely cutting through an electric conductor, stripping one end of such an electric conductor, and crimping a ferrule onto the electric conductor thus stripped.

These pliers 10 comprise a central body 12, to which are secured, on the one hand, a first hand grip 14, the cross section of which is of roughly quadrangular and tubular shape and, on the other hand, a first jaw 16. Articulated to the body 12 is a second hand grip 18 connected to a second jaw 20. The second hand grip 18 is mounted so that it can pivot on the body 12 about an axis of pivoting Y-Y, in a plane P that will be defined as being the plane of gripping of the pliers 10. Each of the hand grips 14, 18 is secured to a cutting blade 22, 23 with a cutting edge intended, when the hand grips 14, 18 are squeezed together, to cut through an electric conductor placed between them.

The two jaws 16, 20 collaborate with one another and are associated with a mechanism known per se which allows an insulated electric conductor to be gripped and then stripped.

The body 12 has a hole 25 formed transversely in a wall of the body 12 and giving access to a crimping chamber 27 formed in the body 12, in which chamber the crimping operation is formed. The hole 25 will be better visible in FIGS. 3, 4 and 5, because the wall of the body 12 has been partially cut away for the purposes of describing the crimping mechanism, which will be done with reference in particular to FIG. 6 which is an enlarged detail of FIG. 2.

The hand grip 14 is provided at its free end with an opening 31 through which a ferrule loader 33 is engaged in the hand grip 14. As will be seen in FIG. 3, the hand grip 14 constitutes a hollow body forming a channel, so that the ferrules 1 present in the loader 33, when the loader is in place, lie at the entrance to the crimping chamber 27, opposite the hole 25 through which the operator can introduce one end of an electric conductor into the first ferrule 1 of the string, and bring it into the crimping chamber 27. The hole 25, which is opposite the crimping chamber 27, is extended towards the free end of the hand grip 14 by an oblong slot 35 that makes it possible to see several consecutive ferrules of one same string, and thus provide the operator with information regarding the number of ferrules remaining in the loader.

Reference is now made to FIG. 3, which depicts the pliers of FIG. 2 in exploded perspective, in order to give a clear depiction of the loader 33, the channel 38 formed in the hand grip 14, and a loader support 40 mounted in the channel 38 and intended removably to accommodate the loader 33.

The loader 33 has the overall shape of a straight strip which is elongate in a main direction that coincides with the main direction of a string of ferrules 1. The loader 33 comprises, in the example depicted, two magazines 42, 43 which are joined together and superposed and each of which is defined by two parallel walls 42A, 42B, 43A, 43B, each pair of walls 42A, 42B, 43A, 43B forming a respective rail which is straight in the longitudinal direction of the loader 33. In the embodiment depicted, each pair of walls 42A, 42B, 43A, 43B has a different spacing designed to accommodate a string of ferrules 1 of different sizes, as have been described with reference to FIG. 1. However, this spacing may be chosen to be the same, it being understood that for a given spacing corresponding to one size of ferrule, several types of ferrule of smaller sizes can be loaded into the magazine.

One 42A, 43A, of the walls of each magazine 42, 43 is secured to a curved metal blade 45, 46 a bent part of which is intended to become inserted between two consecutive ferrules 1, so as to constitute a means of preventing a string of ferrules from sliding in the respective magazine 42, 43. These walls 42A, 43A constitute the outside walls of the loader 33. Formed in one of these walls 43A is an aperture 49 for locking the loader 33 into the support 40. This aperture 49 constitutes a catching member intended to collaborate with a complementary member formed of an elastic tab 51 of the support 40 which tab is provided with a pip.

The support 40 is formed of an elongate slideway running, when mounted in the channel 38, from the free end of the hand grip 14 to the crimping chamber 27. At one of its end, which coincides with a free end region of the hand grip 14, a perforated plate 53 is formed which makes a pivot connection with a journal 55 formed as a projection into the channel 38 transversely with respect to the plane of gripping P, that is to say transversely with respect to the direction in which the ferrules 1 travel. The support 49 may thus pivot in the channel 38 about the common axis Y′-Y′ of the journal 55 and of the perforated plate 53. At that end of the handle 14 which faces towards the crimping chamber 27, the channel 38 has a toothed wall 59 forming two notches 61, while the support 40 is secured to a toothed plate 63 at its opposite end to the perforated plate 53. The toothed plate 63 has a tooth 65 facing towards the notches 61, and designed to collaborate with them in order to define two angular positions of the support 40 about the axis Y′-Y′. The plate 63 also has a tongue 66 elastically urging the toothed plate to return by pressing against the body 12.

Also provided is an operating member 67 in the form of a button which projects from the pliers 10 through an oblong through-hole 69 formed in the hand grip 14, this being secured to the toothed plate 63 and connected to the support 40.

To return the support 40 to one of its angular positions defined by the notches 61, the support 40 is provided with an elastic blade 70 which rests against the bottom of the channel 38, producing, on the front part of the support 40, an upwardly-directed elastic force.

FIGS. 4A and 4B illustrate a second embodiment of the invention, which differs from the first in the means of immobilizing the loader in one or other of its positions. In this embodiment, the two notches 61 and the toothed plate 63 are replaced by a component 164 made of steel wire, for example, in the form of an inverted U-shaped pin. The pin is positioned in the channel 38 in place of the notches 61 of the first embodiment. One of the branches of the U and a part of the connection to the other branch is secured to the body 12 while the other branch is free and has two successive curvatures defining a narrowing of the spacing between the two branches, and thus two notches 161. A post 163 secured to the operating member 67 is connected to the support 40. This post moves between a stable top position and a stable bottom position through the elastic effect of the pin combined with the narrowing forming a “hard point” in the action. It will be noted that the pin has, in one single component, return and positioning functions.

FIG. 5 depicts a first configuration of the pliers 10 and of the loader 33 according to the invention, in which configuration the loader is in one of the two stable positions defined by the notches 61. In this position, the magazines 43 in which is housed a string of ferrules, depicted with large sizes, opens opposite the hole 25 corresponding to the location of the crimping chamber 27, and also opposite the oblong slot 35 (but that is not visible in this figure).

FIG. 6 depicts the configuration making it possible to perform a crimping operation with the ferrules housed in the magazine 42, that is to say with the ferrules depicted with small sizes. The support 40 in this case is placed in another angular position about its axis of pivoting Y′-Y′ and the tooth 65 collaborates with the other notch 61. This position allows the magazine 42 to open opposite the hole 25 that opens onto the crimping chamber 27.

To switch from one of the configurations depicted in FIGS. 5 and 6 to the other, the operator has the possibility of moving the button 67 up or down to cause the support 40, and with it the loader 33, to pivot. He can also manipulate directly that portion of the loader 33 which protrudes from the free end of the hand grip 14. Specifically, the loader 33 is very long; in consequence, when the loader is locked through collaboration of the aperture 49 and of the elastic tab 51 in the support 40, it projects from the pliers 10 from the insertion opening situated at the free end of the hand grip 14.

This length by which the loader 33 protrudes from the hand grip 14 also allows an operator easily to extract the loader 33 from the support 40 and from the hand grip 14, simply by pulling, the locking means consisting of the aperture 49 and the elastic tab 51 being means that can be released through a relatively weak pulling force.

The crimping tool of the pliers 10 and its method of operation will now be described in greater detail with reference to FIGS. 7 to 10.

FIG. 7 depicts a detail of FIG. 2 corresponding to the crimping chamber 27.

Depicted in particular are a series of ferrules 1 in a string, which can be seen through the oblong slot 35, the first of the series 1A of which is placed in the crimping chamber 27 so that it can be crimpedto an electric conductor. A crimping mechanism is arranged in the crimping chamber 27. It comprises an upper part 81 which is fixed with respect to the body 12, this fixed part 81 being in the form of a hollow anvil, the concave side of which faces towards the ferrule 1A that is to be crimped. The anvil 81 is of a size that suits several sizes of ferrule 1, and accommodates the conducting sleeve 5 of the ferrule 1, which conducting sleeve 5 is to be deformed onto the conducting core of the electric conductor.

The crimping tool furthermore comprises a moving lower part 83 which is assigned the functions, this being entirely conventional, of cutting the plastic film 7 and of punching the conducting sleeve 5. The moving part 83 is driven in an essentially translational movement towards the anvil 81 under the action of a link rod 85 articulated about an axis Y″-Y″ which is transversal with respect to the plane of clamping P and to the direction of travel of the string of ferrules.

FIG. 8 is a perspective view of the pliers 10, which depicts, outside the crimping chamber 27, the moving part 83 of the crimping tool and the link rod 85 that drives this moving part 83.

This figure more clearly shows that the link rod 85 comprises two roughly orthogonal branches 88, 89, the link rod 85 being mounted so that it can pivot about the axis Y″-Y″ on a journal 91 secured to the body 12. The first branch 88 of the link rod 85 at its free end has a U-shaped cut-out 93 which fits over a complementary cylindrical post 95 secured to the second hand grip 18, the post 95 thus being capable of sliding in the cut-out 93 and of causing the link rod 85 to turn when an operator moves the two handles 14, 18 together or apart. The second branch 89 of the link rod 85 also has, at its free end, a U-shaped cut-out 97 accommodating a complementary shaft belonging to the moving part 83 and running parallel to the axis Y″-Y″ of the link rod 85. This shaft has been denoted by the reference 99 and comprises a central part 99A (depicted in FIG. 9) which collaborates with the cut-out 97.

It will be readily understood from studying FIG. 8, that the moving part 83 of the crimping tool is moved towards the anvil in a direction roughly orthogonal to the direction of travel of the ferrules 1, this being in the plane of clamping P, when the operator squeezes the two branches 14, 18 of the pliers 10 together.

FIG. 9 depicts only the moving part 83 of the crimping mechanism.

This moving part 83 comprises a punch 101, a cutting member 103 and a centring member 105.

The punch 101 may be made as one piece or, as depicted, as two pieces joined together rigidly, namely a support 110 to which is fixed a serrated blade 112 forming the member which pressures the punch 101 against the conducting sleeve 5 of the ferrule that is to be crimped.

The cutting member 103 has a base 114 and a tapered blade 116 fixed to the said base 114. The tapered blade 116 is of elongate shape and, in the position depicted, runs roughly parallel to the serrated blade 112, one of the ends of the tapered blade 116 being set into the base 114, while the free end 118 is configured as a cutting edge. The base 114 and the support 110 of the punch 101 are joined together via the shaft 99, so that the cutting member 103 has, with respect to the punch 101, freedom for angular excursion about the shaft 99, that is to say about the axis Y′″-Y′″, although they are bound together in terms of translation.

The centring member 105 is formed by an L-shaped block sliding along the base 114 parallel to the tapered blade 116. For this purpose, a first branch 121 of the centring member 105 has a groove 123 that complements the tapered blade 116 so that the latter constitutes a guide for the sliding of the centring member 105 with respect to the base 114, the tapered blade 116 being at least partially inserted in the groove 123 by one of its lateral edges when the centring member 105 is in place on the base 114. The centring member 105 is positioned on the base 114 of the cutting member 103 as follows: the base 114 has a cylindrical recess made parallel to the tapered blade 116, which accommodates a complementary finger 125 formed so that it projects from the lower part of the centring member 105, the finger 125 being surrounded by a spiral-wound spring 129 which rests, on the one hand, around or in the bottom of the recess of the base 114 and, on the other hand, against the underside of the centring member 105. The second branch 131 of this member, which is transversal with respect to the tapered blade 116 and to the direction of travel of the punch 101, comprises two projections forming stops 133 placed one on each side of a lateral edge of the serrated blade 112, the two stops 133 being intended to limit the angular excursion of the assembly formed by the cutting member 103 and the centring member 105 with respect to the punch 101 about the axis Y′″-Y′″ embodied by the shaft 99. The limiting positions thus defined form a first position which is offset angularly towards the rear by a positive angle αₘ, explained later, with respect to the direction of the punch 101, and a second direction which is offset further towards the rear with respect to this punch, by an angle α_{M}>αₘ.

On each side of the tapered blade 116, the first branch 121 of the centring member 105 has, at its free end facing towards the angle 81, an inclined surface which is flat or slightly concave 141 respectively, intended to rest against the respective insulated sleeve 3 of each of the two consecutive ferrules. The two surfaces 141 converge towards the anvil 81.

The way in which the mechanical assembly thus described works will be understood better from reading the description given with reference to FIGS. 10A to 10E which depict successive steps in a crimping operation using pliers according to the invention, as described previously.

These figures depict a series of ferrules 1, the end ferrule 1A of which is offered up to the crimping chamber 27 so as to undergo an operation of crimping onto an electric conductor. The ferrules have been depicted from the side of the insulated sleeve 3, and so the cutting member 103 and centring member 105 are shown in the foreground, while the punch 101, arranged in line with the conducting sleeve 5, appears in the background.

In the phase depicted in FIG. 9A, the punch 101, the centring member 105 and the tapered blade 116 (that is to say the cutting member 103) are at rest under the anvil 81 and under the ferrule 1A that is to be crimped, which ferrule is brought gradually under the anvil 81, by the operator, by means of the electric conductor that is to be crimped in the crimping chamber 27. In this position, the tapered blade 116 and the centring member 105 have a longitudinal axis which is offset angularly with respect to that of the punch 101 (here depicted as vertical) by any angle αA lying between αₘ and α_{M}. This angle αA of offset when the moving member 83 is in the position of rest essentially depends on the position in which the pliers are held by the user, and has no impact on the remainder of the crimping operation given that it can vary freely between the two values αₘ and α_{M}.

FIG. 10B depicts the extreme position of advance of the string of ferrules, the ferrule 1A to be crimped here being brought into abutment against an end wall 143 of the crimping chamber 27. It is when the string of ferrules is in this position that the user generally operates the pliers.

FIG. 10C illustrates operation of the pliers 10, when the hand grips 14, 18 are squeezed together, at the start of the clamping phase. The serrated blade 112 of the punch 110 bears, following a vertical translational movement, on the conducting sleeve 5 of the ferrule 1A while the centring member 105 moves with it in translation in a longitudinal direction of the tapered blade 116, this direction describing the angle of offset αA with respect to the direction of the punch 101 (depicted as vertical).

FIG. 10D illustrates a subsequent phase in the crimping operation, in which phase the pressure of the serrated blade 112 of the punch 101 on the conducting sleeve 5 of the ferrule 1A causes the latter to adopt a stable position wedged into the bottom of the anvil 81. In the example depicted, beyond this position, any additional force exerted to bring the handles 14, 18 closer together causes the reliefs of the serrated blade 112 to bite into the conducting sleeve 5, and causes the centring member 105 and the tapered blade 116 to move further towards the anvil.

FIG. 10E depicts the position at the end of the squeezing-together of hand grips 14, 18, in which position the serrated blade 112 has completed its movement towards the anvil 81 and has fully deformed the conducting sleeve 5, while the centring member 105, pressing via one and/or other of the inclined surfaces 141 of the member 105 on the insulated sleeve of the ferrule 1A that is to be crimped or of the next ferrule, has adopted a stable position resting against the two ferrules. The orientation of the centring member 105 and of the tapered blade 116 depicted here, defines an angle of offset αE generally different from the initial angle αA, given that the ferrules to be crimped have a joining region which forces the centring member 105 to adopt a position which generally differs from the orientation corresponding to the initial offset αA. In the squeezing-together movement of the hand grips 14, 18, from which the deformation of the conducting sleeve 5 results, the centring member 105 is brought into abutment against the insulated sleeve 3 of two consecutive ferrules. By continuing to squeeze the hand grips 14, 18 together, the spring 129 is compressed under the effect of the additional joint movement of the tapered blade 116 and of the serrated blade 112. In the example depicted, the tapered blade 116 fully accompanies the translational movement of the serrated blade 112. In consequence, the tapered blade 116 extracts itself from the groove 123 of the centring member 105 and cuts the plastic film 7 separating two consecutive ferrules, the plastic film being placed, by virtue of the free excursion of the centring member 105 with respect to the punch 101, opposite the cutting edge 118 of the tapered blade 116. FIG. 10E depicts the end-of-travel position of the tapered blade 116, in which position the cutting edge 118 completely cuts the plastic film 7.

It will be appreciated that the mechanical device which has just been described allows automatic centring of the cutting member 103 on the joining region which comprises the plastic film that is to be cut, this being the case of ferrules of different sizes, within the scope of excursion of the cutting member 103 with respect to the punch 101.

The invention which has just been described makes it possible, through simple mechanical means, to produce ferrule crimping pliers with great flexibility of use. An embodiment of the invention in which the ferrule loader 33 comprises two magazines designed to accommodate different types of ferrule has been described, but it would be easily conceivable to design associated crimping pliers and loader such that the loader had a higher number of magazines for ferrules of different types, it being possible for this loader to adopt a corresponding number of positions in the pliers so as to feed the crimping chamber selectively.

The crimping pliers thus produced offer great flexibility of use because the operator can very quickly and through a very simple action change the type of ferrules ready to be crimped.

The invention affords a considerable saving in time over current wiring operations in an industrial environment, without significantly increasing the cost of manufacture of the tool.

The invention furthermore makes it possible to perform precise cutting of the plastic film separating the ferrules in string form, avoiding the need for the operator to manually adjust the angle of offset of the cutting member with respect to the punch each time he changes ferrule type.

In particular, if use is made of a single loader comprising several magazines accommodating various types of ferrule, this loader being moveable between several positions corresponding to the feeding of the crimping chamber by these various magazines, the operator is offered the possibility of frequently changing the type of ferrule to be crimped without performing painstaking operations, and he avoids the need to make tricky adjustments each time he makes such changes.

1. Hand tool for crimping ferrules, particularly of the pliers type, comprising a body (12) extended by a first branch (14) forming, in particular, a hand grip, and a second branch (18) forming, in particular, a hand grip, articulated to the body (12), a crimping chamber (27) being formed in the said body (12) and opening to the outside of the body (12) via a passage (25) for the introduction of one end of an electric conductor into the said crimping chamber (27), a channel (38) being formed in the said body (12) and/or the said first branch (14), a ferrule loader (33) arranged at least partially and removably in the said channel (38) so as to open into the crimping chamber (27), the loader (33) comprising at least two magazines (42, 43) designed each to receive a number of ferrules, characterized in that the loader (33) is mounted so that it can be moved in the channel (38) between at least two positions in which just one of the magazines (42, 43) opens opposite the passage (25), and the said tool comprises locking and selecting means (40, 49, 51, 61, 65, 69; 163, 164) designed to hold the loader (33) in the channel (38) in one of the said positions selectively.

2. Hand tool according to claim 1, characterized in that the said magazines (42, 43) are joined together and superposed.

3. Hand tool according to claim 1, characterized in that the said magazines (42, 43) are of the same size.

4. Hand tool according to claim 1, characterized in that the said magazines (42, 43) are of different sizes.

5. Hand tool according to claim 1, characterized in that the first branch (14) is of elongate shape and has a free end at the opposite end to the body (12), the said free end having an opening (31) for introducing the loader (33).

6. Hand tool according to claim 1, characterized in that the locking and selecting means (40, 49, 51, 61, 65, 67; 163, 164) comprise a moving support (40) accommodating the loader (33) and provided with means (51) of immobilizing the said loader (33), the said moving support (40) being able to be moved in the channel (38) between at least two positions corresponding respectively to the positions in which one of the magazines (42, 43) opens opposite the passage (25).

7. Hand tool for crimping ferrules, particularly of the pliers type, comprising a body (12) extended by a first branch (15) forming, in particular a hand grip, and a second branch (18) forming, in particular, a hand grip, articulated to the body (12), a crimping chamber (27) being formed in the said body (12) and opening to the outside of the body (12) via a passage (25) for the introduction of one end of an electric conductor into the said body (12) and/or the said crimping chamber (27), a channel (38) being formed in the said first branch (14) and opening into the crimping chamber (27), characterized in that a moving support (40) designed to accommodate a ferrule loader (33) is mounted in the channel (38) between at least two positions with respect to the passage (25) for the introduction of the electric conductor.

8. Hand tool according to claim 7, characterized in that the moving support (40) is connected to a toothed plate (63) collaborating selectively with at least two notches (61) formed in the channel (38) so as to define the said at least two positions of the support (40).

9. Hand tool according to claim 7, characterized in that the moving support (40) has a post (163) collaborating with a roughly U-shaped pin (164) which is bent in such a way that it has at least two notches (161) for retaining the post (163), defining the said at least two positions of the support (40).

10. Hand tool according to claim 8, characterized in that the moving support (40) is provided with an elastic blade (71) which projects from the said support (40) and bears against a wall of the channel (38) so as to constitute a member that elastically returns the support (40) to one of its positions defined by the notches (61; 161).

11. Hand tool according to claim 8, characterized in that the means (51) of immobilizing the loader (33) in the moving support (40) comprise an elastic tab (51) formed on the support (40), and designed to collaborate with a complementary aperture (49) formed in the loader (40).

12. Hand tool according to claim 7, characterized in that the moving support (40) is a tilting support capable of pivoting between at least two angular positions, about a pivot (55).

13. Hand tool according to claim 12, characterized in that the pivot (55) is located near the free end of the first branch (14).

14. Hand tool according to claim 7, characterized in that the loader (33), when locked in the channel (38), projects from the tool (10) through the said opening (31).

15. Hand tool according to claim 7, characterized in that the passage (25) is an oblong slot giving access to the selected magazine (42, 43) over a length greater than the diameter of a ferrule (1).

16. Ferrule loader for a crimping hand tool according to claim 7, the said loader (33) being in the form of a strip which is elongate in a main direction, in which a series of ferrules (1) of the same size, connected together, is held between a pair of roughly parallel walls (42A, 42B, 43A, 43B) forming a magazine (42, 43), the said series of ferrules (1) being able to slide as a unit in the main direction between the said walls (42A, 42B, 43A, 43B), the loader being characterized in that it has at least two such magazines (42, 43) running parallel to one another and designed each to accommodate a number of different ferrules.

17. Ferrule loader according to claim 16, characterized in that it has a catching member (49) intended to collaborate with a complementary member (51) of a loader support (40) mounted in the tool (10).

18. Tool for crimping strings of ferrules, the said string being intended to travel in its longitudinal direction, the said tool comprising a body (12) in which there is formed a crimping chamber (27) opening to the outside of the body (12) via a passage (25) for the introduction of one end of a wire-like element into the said chamber (27), a crimping mechanism arranged in the said crimping chamber (27), the said mechanism comprising an anvil (81) designed to accommodate part (5) of a ferrule that is to be crimped, a moving punch (101) intended to deform the said part (5) by pressing it against the said anvil (81), and a moving member (103) for cutting the string (7), characterized in that the cutting member (103) is capable of excursion with respect to the direction of action of the punch (101).

19. Crimping tool according to claim 18, characterized in that the cutting member (103) is connected to the punch (101) in such a way as to be moved with the punch (101), and the cutting member (103) is further capable of angular excursion with respect to the punch (101), about an axis (Y′″-Y′″) which is roughly transversal with respect to the direction of travel of the string.

20. Crimping tool according to claim 18, characterized in that the punch (101) can move with respect to the anvil (81) in a roughly translational movement.

21. Crimping tool according to claim 20, characterized in that the moving cutting member (103) is connected to the punch (101) in such a way as to be moved in translation with the punch (101).

22. Crimping tool according to claim 21, characterized in that the moving cutting member (103) is connected to the punch (101) in such a way as to be moved as one with the punch (101).

23. Crimping tool according to claim 18, characterized in that the cutting member (103) supports a centring member (105) designed to rest against two consecutive ferrules (1) of the string, in a region where the ferrules (1) are joined, while the punch (101) moves towards the anvil (81).

24. Crimping tool according to claim 23, characterized in that the centring member (105) is mounted to slide on the cutting member (103) in the direction of travel of the said cutting member (103).

25. Crimping tool according to claim 24, characterized in that the centring member (105) comprises stops (133) collaborating with the punch (101) so as to limit the angular excursion of the centring member (105) and, at the same time, of the cutting member (103), with respect to the punch (101).

26. Crimping tool according to claim 24, characterized in that the centring member (105) is connected to the cutting member (103) via an elastic return means (129) acting in the direction of sliding.

27. Crimping tool according to claim 18, characterized in that the cutting member (103) comprises a blade (116) which extends mainly in the direction of travel of the cutting member (103), the said blade (116) being fixed, by its opposite end to the string, to a base (114), while the other end of the said blade (116) is free and has a cutting edge (118).

28. Crimping tool according to claim 24, in which the cutting member (103) comprises a blade (116) which runs mainly in the direction of travel of the cutting member (103), the said blade (116) being fixed, by its opposite end to the string, to a base (114), while the other end of the said blade (116) is free and has a cutting edge (118), characterized in that the centring member (105) has a groove (123) running in the main direction of the blade (116) and collaborating with the said blade, so that the blade (116) constitutes a guide for the sliding of the centring member (105) with respect to the cutting member (103).

29. Crimping tool according to claim 19, in which the cutting member (103) comprises a blade (116) which runs mainly in the direction of travel of the cutting member (103), the said blade (116) being fixed, by its opposite end to the string, to a base (114), while the other end of the said blade (116) is free and has a cutting edge (118), characterized in that the base (114) is mounted to pivot on the punch (101) about the said axis (Y′″-Y′″).

30. Crimping tool according to claim 18, consisting of pliers, the said pliers comprising a body (12) extended by a first branch (14) forming a hand grip and by a second branch (18) forming a hand grip, articulated to the body (12), a channel (38) being formed in the said first branch (14), the said channel (38) removably accommodating a ferrule loader (33) and opening into the crimping chamber (27), characterized in that the loader (33) comprises at least two magazines (42, 43) corresponding respectively to ferrules of different sizes, and the pliers (10) comprise locking and selecting means (40, 49, 51, 61, 65, 67) designed to hold the loader (33) in the channel (38) in, selectively, one of the positions in which one of the magazines (42, 43) opens opposite the passage (25).
